(19) United States
(12) Patent Application Publication
(10) Pub. No.: US 2007/0095840 A1
(43) Pub. Date: May 3, 2007

(54) Fastening device

(76) Inventors: Marc Gerhardt, Dortmund (DE); Thomas Zapp, Dortmund (DE)

Correspondence Address: MAYER, BROWN, ROWE & MAW LLP, P.O. BOX 2828, CHICAGO, IL, 60690-2828, US

(21) Appl. No.: 10/560,845

(22) PCT Filed: May 26, 2004
(86) PCT No.: PCT/EP04/50919

§ 371 Date: Dec. 15, 2005

(30) Foreign Application Priority Data
Jun. 17, 2003 (DE) 10327525.8

(51) Int. Cl. F04B 35/00; B62D 33/00

(52) U.S. Cl. 220/562; 417/360

(57) ABSTRACT

The invention relates to a fastening device for components to be mounted in a fuel tank of a motor vehicle. The fastening device comprises a fastening element, a head part, which is joined to a base part such as the wall of the fuel tank, and a head part that is placed on a component. Respective head parts which are provided for fastening a line to be lead through the wall of the fuel tank, have a continuous duct. A head part on a base part and a head part on a component are pressed together and are made from a material that swells when brought into contact with fuel. This enables the line to be easily fastened to a wall of the fuel tank whereby being sealed with regard thereto.

### BACKGROUND OF THE INVENTION

The invention relates to a fastening device, having a fastening element, for components to be arranged in a fuel tank of a motor vehicle.

Fastening devices of this type are often used, for example, for fastening a feed unit, a suction jet pump, lines or the like and are therefore known. In this case, the components to be arranged in the fuel tank, which is manufactured in a blow-molding process, are generally fastened to a flange to be inserted in an opening of the fuel tank and clamped, by way of example, to the base. The disadvantage in this case is that this fastening device requires a very large outlay in terms of construction.

Alternatively, it is known from experience to fixedly weld the components to be arranged in the fuel tank directly to the wall. This fastening is however very complex and requires tooling to fuse the wall and the component.

### SUMMARY OF THE INVENTION

The invention is based on the problem of further developing a fastening device of the type mentioned in the introduction in such a way that it is of particularly simple structural design.

This problem is solved according to the invention by virtue of the fact that the fastening element has a head part arranged on the base part and a head part arranged on the component and by virtue of the fact that the head parts can be connected to one another in a non-positive manner.

This design allows the component provided with the head part to be easily mounted on the head part on the base part. A plurality of fastening elements may of course be provided in the case of large components to be arranged in the fuel tank. For this purpose, a corresponding number of head parts are to be arranged on the base part only in that region of the wall of the fuel tank in which the components are arranged. In this way, the fastening device according to the invention is of particularly simple structural design. In addition, the design according to the invention of the fastening device results, in the case of a large number of components, in a particularly simply constructed fuel tank. The non-positive connection is achieved as a result of the swelling of the component. In addition, a positive connection is generated.

The fastening device according to the invention can be easily produced if at least one of the head parts of the fastening element is of sleeve-shaped design. The other head part of the fastening element may in this case likewise be designed in the form of a sleeve or bolt-shaped. In addition, large components which are fastened to the wall with a plurality of fastening elements according to the invention may be easily oriented in their intended position by means of an appropriately forceful insertion of the head part into the base part.

Lines such as ventilation lines or a fuel line are often guided through the wall of the fuel tank. The lines are laid within the fuel tank and connected to a connector arranged in the wall. According to another advantageous development of the invention, lines of this type can be easily fastened and simultaneously connected to the connector if the fastening element has a duct running continuously through the head parts of the base part and of the component and if the head parts are sealingly connected to one another. The base part may additionally have a ventilation nipple.

According to another advantageous development of the invention, the connection of the head parts can be of particularly simple design if one of the head parts has circumferential edges facing radially in the direction of the respective other head part. As a result, one head part can be easily mounted on the other head part and thus be fastened in a non-positive manner or, with appropriate design of the region facing the edges, in a positive manner to the base part.

According to another advantageous development of the invention, the components can be easily fastened to the wall of the fuel tank and are difficult to remove if the circumferential edges have a bevel in their regions facing toward the other component and a shoulder in their regions facing away from the other components. As a result, the edges have a sawtooth-shaped cross-sectional profile.

Sealing elements to be mounted in an additional working operation can be easily eliminated, particularly in the case of the fastening elements according to the invention and having the duct, if one part of the circumferential edges is designed as a fastening region and the other part is designed as a sealing region.

According to another advantageous development of the invention, the fastening region requires a particularly low outlay in terms of construction if a part of the circumferential edges is designed to be radially rigid.

According to another advantageous development of the invention, a duct led through the fastening element can be easily sealed off from the fuel tank if a part of the circumferential edges is designed to be radially flexible.

The fastening device according to the invention has a particularly high holding force for the components to be fastened in the fuel tank and a reliable impermeability if at least one of the components of the fastening element, in its region facing the respective other component, is produced from a material which is swellable in conjunction with fuel. By way of example, the plastics polyoxymethylene (POM) or polyamide (PA) are suitable as swellable material in the case of present-day fuels. As a result of the plastic properties creep and swelling and also the mechanical pressing of the head part to the base part, a connection which cannot be detached without being destroyed is generated.

In the case of lines with high internal pressure which are to be guided through the wall of the fuel tank, such as a supply line leading to an internal combustion engine of a motor vehicle, a high impermeability of the fastening can easily be ensured according to another advantageous development of the invention if one of the head parts has a circumferential groove for holding a sealing ring.

The fastening device according to the invention requires a particularly low outlay in terms of assembly if the components of the fastening element are produced in one part with the wall of the fuel tank and with the component to be assembled. The components of the fastening elements can therefore, particularly in the case of fuel tanks and components to be arranged therein produced from plastic by injection molding, be easily molded on integrally during their production.

According to another advantageous development of the invention, subsequent fastening of a component in the fuel tank can be effected particularly easily if the head parts are fastened in one piece with the base part or the component. The fastening may take place by welding, adhesive bonding or positive connection. In the case of fuel tanks or components made from steel, the head parts are preferably riveted.

The fastening device according to the invention has a particularly high stability if one or both head parts have lateral support webs.

### BRIEF DESCRIPTION OF THE DRAWINGS

The invention permits a large number of embodiments. In order to further clarify their basic principle, several of these are illustrated in the drawing and are explained in the following.

In the drawing:

FIG. 1 shows a sectioned illustration through a fuel tank with components fastened therein;

FIG. 2 shows a greatly enlarged illustration of a fastening device according to the invention for a line guided through the wall of the fuel tank in FIG. 1; and

FIG. 3 shows a sectioned illustration through two fastening devices according to the invention in the fuel tank in FIG. 1.

### DETAILED DESCRIPTION OF THE PREFERRED EMBODIMENTS

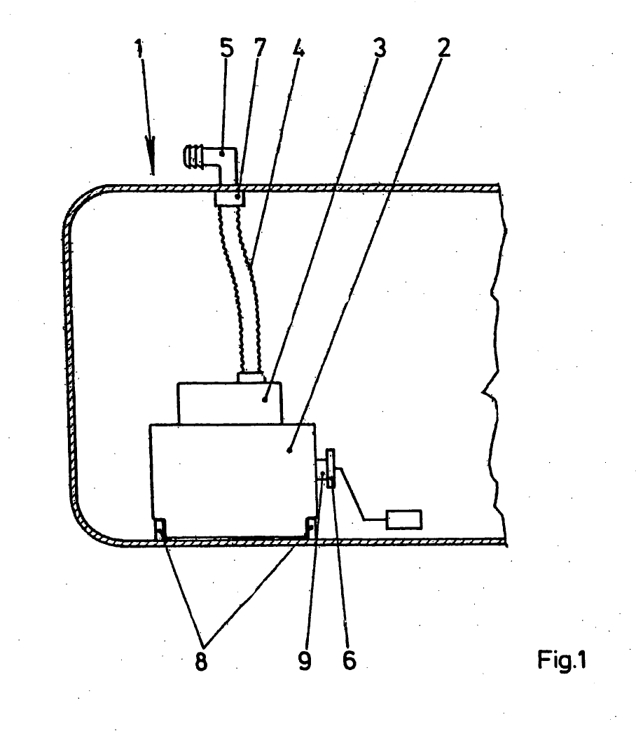

FIG. 1 shows a sectioned illustration through a partial region of a fuel tank 1 with a surge pot 2 and a feed unit 3 arranged therein. A line 4 designed as a corrugated pipe adjoins the feed unit 3, which line is connected to a connecting nozzle 5 arranged on the outside of the wall of the fuel tank 1. The line 4 may for example be a supply line leading to an internal combustion engine (not illustrated) of the motor vehicle. A lever sensor 6 is fastened to the surge pot 2. The line 4 and the surge pot 2 are fastened to the inner wall of the fuel tank 1 with fastening elements 7, 8. The lever sensor 6 likewise has a fastening element 9 in order to fasten it to the surge pot 2.

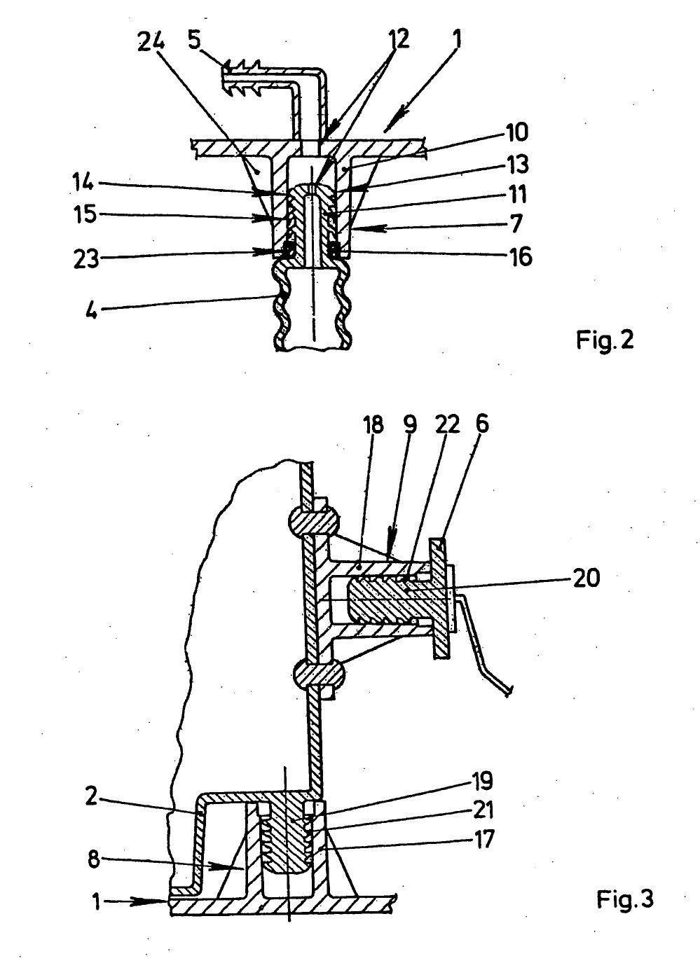

FIG. 2 shows a sectioned illustration of the fastening of the line 4 to the wall of the fuel tank 1 in FIG. 1. The fuel tank 1 in this case forms the base part. The fastening element 7 has a sleeve-shaped head part 10 which is produced in one part with the wall. A head part 11, likewise of sleeve-shaped design, of the line 4 is pushed into the head part 10. The head part 10 and the head part 11 have a continuous duct 12. The head part 11 has a plurality of circumferential, radially protruding edges 13, by means of which it is held in a non-positive manner in the head part 10 during assembly. As a result of the swelling of the plastic parts in the fuel, the pressing is assisted and/or an additional positive connection is achieved. A part of the edges 13 is designed to be rigid by means of a sawtooth shape and forms a fastening region 14 of the fastening element 7. The remaining edges 13 are designed to be radially flexible and form a sealing region 15 of the fastening element 7 with a flat support on the head part 10. Furthermore, a sealing ring 16 is arranged in a groove 23 between the head part 11 and the head part 10. This sealing ring 16 is not necessary in the case of unpressurized lines such as a return line or a ventilation line. Furthermore, FIG. 2 shows that the head part 10 has lateral side webs 24.

FIG. 3 shows a sectioned illustration through a partial region of the surge pot 2 in FIG. 1 with one of the fastening elements 8 for fastening it to the wall of the fuel tank 1 and the fastening element 9 for fastening the lever sensor 6. The fastening elements 8, 9 respectively have a sleeve-shaped head part 17, 18 and a head part 19, 20 of bolt-shaped design which is pressed into the head part 17, 18. The head parts 19, 20 respectively have circumferential edges 21, 22, by means of which they interlock with the head part 17, 18. A high degree of pressing of the head part 19, 20 to the head part 17, 18 is ensured by means of swelling with fuel. This results in high holding forces of the fastening element 8, 9. The head part 17 of the fastening element 8 for the surge pot 2 is produced in one piece with the wall of the fuel tank 1 while the head part 18 for the lever sensor 6 is riveted to the surge pot 2. In an alternative embodiment, the head parts may of course be of sleeve-shaped design and engage over the head parts 17, 18.

1. A fastening device, having a fastening element, for components to be arranged in a fuel tank of a motor vehicle, wherein the fastening element has a head part arranged on a base part and has a respective corresponding head part (11, 19, 20) arranged on a component, and wherein the head part on the component and the head part on the base part are adapted to be connected to one another in a non-positive and positive manner.

2. The fastening device as claimed in claim 1, wherein at least one of the respective head parts of the fastening element is of sleeve-shaped design.

3. The fastening device as claimed in claim 1, wherein the fastening element has a duct running continuously through the respective head parts on the component and on the base part and the head parts on the component and on the base part are sealingly connected.

4. The fastening device as claimed in claim 1, wherein the head part on the component or the head part on the base part has circumferential edges facing radially toward the respective other head part.

5. The fastening device as claimed in claim 1, wherein the circumferential edges have a bevel in regions facing toward the respective other head part and a shoulder in regions facing away from the respective other head part.

6. The fastening device as claimed in claim 4, wherein one portion of the circumferential edges is designed as a fastening region and the head part further comprises a portion designed as a sealing region.

7. The fastening device as claimed in claim 4, wherein a portion of the circumferential edges is designed to be radially rigid.

8. The fastening device as claimed in claim 4, wherein a portion of the circumferential edges is designed to be radially flexible.

9. The fastening device as claimed in claim 5, wherein at least one of the respective head parts of the fastening element, in a region facing toward the respective other head part, is produced from a material which is swellable in conjunction with fuel.

10. The fastening device as claimed in claim 1, wherein the head part on the base part or on the component has a circumferential groove for holding a sealing ring.

11. The fastening device as claimed in claim 1, wherein at least one of the respective head parts of the fastening element is produced in one part with a wall of a fuel tank and at least one of the respective other head parts is produced in one part with the component to be assembled.

12. The fastening device as claimed in claim 1, wherein a head part is fastened to the component or a head part is fastened to a wall of the base part.

13. The fastening device as claimed in claim 1, wherein the head part on the base part has lateral support webs or the head part on the component has lateral support webs.

14. The fastening device as claimed in claim 2, wherein the fastening element has a duct running continuously through the respective head parts on the component and on the base part and the head parts on the component and on the base part are sealingly connected.

15. The fastening device as claimed in claim 1, wherein the head part on the component or the head part on the base part has circumferential edges facing radially toward the respective other head part.

16. The fastening device as claimed in claim 11, wherein the circumferential edges have a bevel in regions facing toward the respective other head part and a shoulder in regions facing away from the respective other head part.

17. The fastening device as claimed in claim 11, wherein one portion of the circumferential edges is designed as a fastening region and the head part further comprises a portion designed as a sealing region.

18. The fastening device as claimed in claim 11, wherein a portion of the circumferential edges is designed to be radially rigid.

19. The fastening device as claimed in claim 11, wherein a portion of the circumferential edges is designed to be radially flexible.

20. The fastening device as claimed in claim 11, wherein at least one of the respective head parts of the fastening element, in a region facing toward the respective other head part, is produced from a material which is swellable in conjunction with fuel.
